(19) United States
(12) Patent Application Publication
(10) Pub. No.: US 2009/0007124 A1
(43) Pub. Date: Jan. 1, 2009

(54) Method and mechanism for memory access synchronization

(76) Inventor: Mingnan Guo, Burnaby (CA)

Correspondence Address: MINGNAN GUO, P.O. Box 19343 Metrotown, Burnaby, BC, V5H 4J8, omitted

(21) Appl. No.: 12/144,163

(22) Filed: Jun. 23, 2008

Related U.S. Application Data
(60) Provisional application No. 60/946,393, filed on Jun. 27, 2007.

(51) Int. Cl. G06F 9/46; G06F 1/12

(52) U.S. Cl. 718/103; 713/375; 718/100

(57) ABSTRACT

The present invention is a method and mechanism of multiple processors synchronization. Calling global memory fence (GMF) service raises asynchronous memory fence being executed on other processors. By guarantee that asynchronous memory fence (AMF) or equivalence on other processors are executed within the window of global memory fence (GMF) service call, the expensive memory ordering semantics can be removed from the critical path of frequently-executed application code. Therefore, the overall performance is improved in modern processor architectures.

### CROSS REFERENCE TO RELATED APPLICATION

This application is based on and hereby claims priority to U.S. Application No. US60/946,393 filed on 27 Jun. 2007, the contents of which are hereby incorporated by reference.

### FIELD OF THE INVENTION

The present invention relates to memory access in a computer system. More specifically, the present invention relates to a method and mechanism for synchronization of memory access in a modern multi-processors architecture.

### BACKGROUND OF THE INVENTION

In order to achieve high performance, many modern processor architectures use relaxed memory ordering models. Instructions might be executed out-of-order and/or be seen by other processors out-of-order. Different processor architectures provide various memory-ordering semantics to enforce further ordering relationships between memory accesses. But, applying memory ordering semantics to application will significantly impact the performance, especially in a frequently-executed path of instruction.

For example, Itanium Architecture has a relaxed memory ordering model which provides unordered memory opcodes, explicitly ordered memory opcodes, and a fencing operation that software can use to implement stronger ordering. Each memory operation establishes an ordering relationship with other operations through one of four semantics:
Unordered semantics imply that the instruction is made visible in any order with respect to other orderable instructions.
Acquire semantics imply that the instruction is made visible prior to all subsequent orderable instructions.
Release semantics imply that the instruction is made visible after all prior orderable instructions.
Fence semantics combine acquire and release semantics (i.e. the instruction is made visible after all prior orderable instructions and before all subsequent orderable instructions).

In the above definitions “prior” and “subsequent” refer to the program-specified order. An “orderable instruction” is an instruction that the memory ordering model can use to establish ordering relationships. The term “visible” refers to all architecturally-visible (from the standpoint of multiprocessor coherency) effects of performing an instruction. Specifically,
Loads from cacheable memory regions are visible when they hit a non-programmer-visible structure such as a cache or store buffer.
Stores to cacheable memory regions are visible when they enter a snooped (in a multiprocessor coherency sense) structure.

The Itanium architecture does not provide all possible combinations of instructions and ordering semantics. For example, the Itanium instruction set does not contain a store with fence semantics. A load instruction has either unordered or acquire semantics while a store instruction has either unordered or release semantics.

In cases that algorithms need some strict ordering of some crucial operations, using ordering semantics may impact the performance in modern architectures, such as in Itanium Architecture Family (IPF).

For example, in one of incremental or concurrent garbage collection algorithms, when an application thread (also known as Mutator) create a new reference to an object, it should save the reference to its place (SaveRef operation) and check a flag (ChkFlag operation) to determine whether or not a garbage collection is in progress. If there is a garbage collection (the Collector) running, then a GCBarrier operation must be conducted to store the object reference into a list that can be checked by the collector later. The collector always set the flag (SetFlag operation) prior to actual garbage collection, such as reference traversal. The Collector must not miss both the outcomes of SaveRef and GCBarrier operations, at least one of them must be seen by the Collector. Since GCBarrier operation is depended on the ChkFlag operation, there are 4 vital operations: SaveRef, ChkFlag, SetFlag and GC operations. We can express their relation as follows with Intel memory ordering notation. In Intel memory ordering notation, given two different memory operations X and Y, X>>Y specifies that X precedes Y in program order and X→Y indicates that X is visible if Y is visible (i.e. X becomes visible before Y). Therefore, we have following program order:
Mutator: SaveRef [memory 1]>>ChkFlag [memory 2]
Collector: SetFlag [memory 2]>>GC Traversal [memory 1]

Further, abstract notation can be derived from above, as SaveRef and SetFlag are memory-write operations; ChkFlag and GC (Reference Traversal) are memory-read operations. We replace SaveRef and GC by W[x] and R[x] respectively to notate the memory access to reference location ‘x’, and replace SetFlag and ChkFlag by W[y] and R[y] respectively to notate the memory access to the flag variable ‘y’. We get follows:
#0: W[y]>>R[x]
#1: W[x]>>R[y]

Suppose all original memory locations contain zero prior to these operations. The goal is to guarantee that the R[x] and R[y] operations should not see both x and y are zero.

One solution is to use memory semantics to enforce strict ordering the same as the program order of these operations. The first operation for both threads are write operations, so the first operation of these four operations must be a write, and then later read operations will see the result of the write operation, a non-zero value. However, using such strict ordering semantics lead to lower performance than a relaxed ordering, especially when the ordering semantics is applied on a frequently-executed critical path, such as the SaveRef and ChkFlag operations of Mutator in above example. Software should use unordered instructions whenever possible for best performance.

Without introducing any memory ordering semantics, the execution of W[x/y]>>R[y/x] in #0/#1 might be out of order in most modern processor architectures. For example, in x86 machine (IA32), loads are allowed to pass (be carried out ahead of) stores. So R[y] might be carried out ahead of W[x], and we might get the following global ordering: R[y]→W[y]→R[x]→W[x], which both x and y are seen zero by the end. Notice that, even the ordering on processor #0 constrains to the same of program order W[y]→R[x], the result is incorrect.

As demonstrated by above examples, people need a new method and mechanism to eliminate the need of memory ordering constraints in critical path to achieve the best performance while in the mean time the correctness is preserved. In another word, we don't want to add any memory semantics constraints on W[x] (SaveRef), R[y] (ChkFlag) in the Mutator #1, but want to be guaranteed that the program should not see both x and y are zero. Herein, a high performance method and mechanism are given to fulfill the requirement.

### SUMMARY OF THE INVENTION

In view of the above requirements, an object of the present invention is to provide a mechanism that remove memory ordering constraints on some critical execution path to improve the performance.

The object stated above is achieved by the present invention in the following manner: a service of global memory fence (GMF) is provided, which program code can call it to synchronize executions of other threads on multiple processors. The GMF service notifies or interrupts other processors to cause them execute an asynchronous memory fence (AMF) operation, which guarantee that at least one memory fence instruction or equivalence are carried out on each other processors. Meanwhile, the GMF service waits until it is confirmed that all required AMF operations have completed on their own processors. When the GMF service call returns to the caller, the system guarantees that after initiating the GMF call, every other running threads or processors has asynchronously executed and completed at least one memory fence instruction or equivalence. Therefore, operations prior to a GMF are visible before subsequent operations of the AMF; and operations prior to an AMF are visible before subsequent operations of the GMF.

One embodiment of the present invention uses inter-processor interrupts (IPI) to generate asynchronous memory fence on other processors. The global memory fence service is provided by codes in operating system kernel such as a system call service or a device driver. The code of GMF service sends IPI messages to all or concerning processors. The caller of GMF can specify it's concerning processors via parameters or environments. The processor that receives the IPI message raises an asynchronous interrupt and transfers the execution into kernel mode. Interrupt handler code for the interrupt will execute a memory fence instruction. That is the asynchronous memory fence executing on another processor. After executing the memory fence instruction, the interrupt handler notifies other processors via shared memory, and the last AMF interrupt handler will wake up the GMF thread by multi-threading synchronization mechanisms.

Another embodiment of the present invention uses processor affinity mechanism of application thread to achieve the same effect. Instead provided in kernel mode, the whole GMF service can be provided in user mode. At the beginning, N dedicated threads are created with processor affinity property set to each processor in the system, suppose there are N processors in the system. These threads are blocked on some synchronization objects via which the GMF service code can wake them up. Because these threads have been set to running on designated processor respectively, once one of them gains the control and runs on the designated processor, the original running thread on the designated processor is sure to be preempted. When the last thread is waked up, it wakes up the sleeping GMF thread meaning all AMF operations have done.

By the GMF services, the memory ordering semantics can be removed from its critical path. Such as in above example, people can use unordered instructions for operations W[x]>>R[y] in thread #1, while in thread #0 the code is changed to W[x]>>GMF>>R[y], as a result we can guarantee that R[x] and R[y] will not see both x and y are zero. Therefore, the performance of thread #1 is improved substantially. This mechanism can be applied to various algorithms that require a memory ordering of operations. Also, a wide array of modern computer platforms can benefit from it.

A more complete understanding of the present invention, as well as features and advantages of the present invention, will be obtained with reference to the following detailed description and drawings.

### BRIEF DESCRIPTION OF THE DRAWINGS

FIG. 1 is a block diagram of a platform supporting some embodiments of the present invention;

FIG. 2 is a schematic of relationship between GMF and AMFs;

FIG. 3 shows the relationship of application instructions around GMF and AMF;

FIG. 4 shows an application example of GMF mechanism;

FIG. 5 illustrates application program calls GMF service and generating AMF interrupts in embodiment 1;

FIG. 6 is a flowchart of GMF and AMF code in embodiment 1;

FIG. 7 is a flowchart of D thread and GMF code in embodiment 2.

### DETAILED DESCRIPTION OF PREFERRED EMBODIMENTS

In the following description, for the purposes of explanation, numerous specific details are set forth in order to provide a thorough understanding of the present invention. It is apparent, however, to one skilled in the art that the present invention may be practiced without these specific details or with an equivalent arrangement.

FIG. 1 is a block diagram of computer system, which supports some embodiments of the present invention. Referring to FIG. 1 there is a computer system, which can be personal computer, personal digital assistant, smart phone, center server or other computation device. As a typical sample, the computer system 100 comprises a main processing unit 101 and power unit 102. The main processing unit 101 comprises one or more processors 103, and is connected to one or more memory storage unit 105 through system circuit 104. One or more interface devices 106 are connected to processors 103 through system circuit 104. In the present example, system circuit 104 is an address/data bus. A person skilled in the art can use other ways to connect those elements, such as using one or more dedicated data lines, or a switcher to connect processors 103 and memory storage unit 105.

Processors 103 include any processors, such as those in the Intel Pentium™ family, or Intel Itanium™ family. Memory storage unit 105 includes random access memory, such as DRAM. In this example, the memory storage unit 105 stores codes and data for execution by processor 103. Interface circuit 106 can use any standard interface, such as USB, PCI, PCMCIA, etc. One or more input devices 107 including keyboard, mouse, touch pad, voice recognition device, etc, are connected to main process unit 101 through one or more interface circuit 106. One or more output devices 108 including monitor, printer, speaker, etc, are connected to main process unit 101 through one or more interface circuit 106. The platform system can also include one or more external storage units 109, including a hard disk, CD/DVD, etc. The system connects to and exchanges data with other external computer devices through network device 110, which includes Ethernet, DSL, dial-up, wireless network, etc. The program code of the present invention can be stored in the memory storage unit 105 as described in FIG. 1 on a computation device.

In the present invention, memory fence instruction or equivalence is one of the key components and is intensively used to build up the whole mechanism. Memory fence instructions generally are instructions provided by various processor architectures. A memory fence instruction guarantees that the instruction is made visible after all prior instructions and before all subsequent instructions. Instructions herein are referred to orderable memory access operations, such as load, store and read-modify-write semaphore operations. For example, IA32 architecture provides MFENCE instruction to guarantee that, every load and store instruction that precedes in program order the MFENCE instruction is globally visible before any load or store instruction that follows the MFENCE instruction is globally visible. IA64 provides “mf” instruction to ensure all prior data memory accesses are made visible prior to any subsequent data memory access being made visible. Power PC provides “sync” instruction to ensure that all instructions preceding the sync instruction appear to have completed before the sync instruction completes, and that no subsequent instructions are initiated by the processor until after the sync instruction completes. Also, for some platform, a combination of memory ordering semantics might have the same effects as memory fence instruction in respects to memory ordering. Herein, the combination of instructions is treated as memory fence operation in the present invention.

Interrupt and asynchronous execution is another key component in this invention. Interrupt herein means external asynchronous events, such as clock, I/O event and inter-processor interrupt. The original execution instruction flow is interrupted and the control is transferred to an interrupt handler routine.

In some modern processor architectures, interrupt can be handled on-the-fly as memory operations from the interrupted program may still in-flight and not yet visible to other processors. Context switch, on the other hand, always guarantee that all memory operations prior to the context switch are made visible before the context changes. Without this requirement, if the thread migrates to a different processor after context switch, it might violate the ordering constraints of application program.

The present invention comprises: a global memory fence (GMF) service that program code can call it, and several asynchronous memory fence (AMF) code that run on other processors respectively. When user program calls the GMF service, the GMF service code notifies or interrupts other processors to cause them execute an asynchronous memory fence (AMF) code, which guarantee that at least one memory fence instruction or equivalences are carried out on each interrupted processors. Meanwhile, the GMF service waits until it is confirmed that all required AMF codes have completed on their own processors. After that, the GMF service returns to the caller, and the system guarantees that after initiating the GMF call, every other running threads or processors is asynchronously interrupted and executes at least one memory fence instruction or equivalences, and these memory fence operations on other processors have done prior to the return of the GMF service.

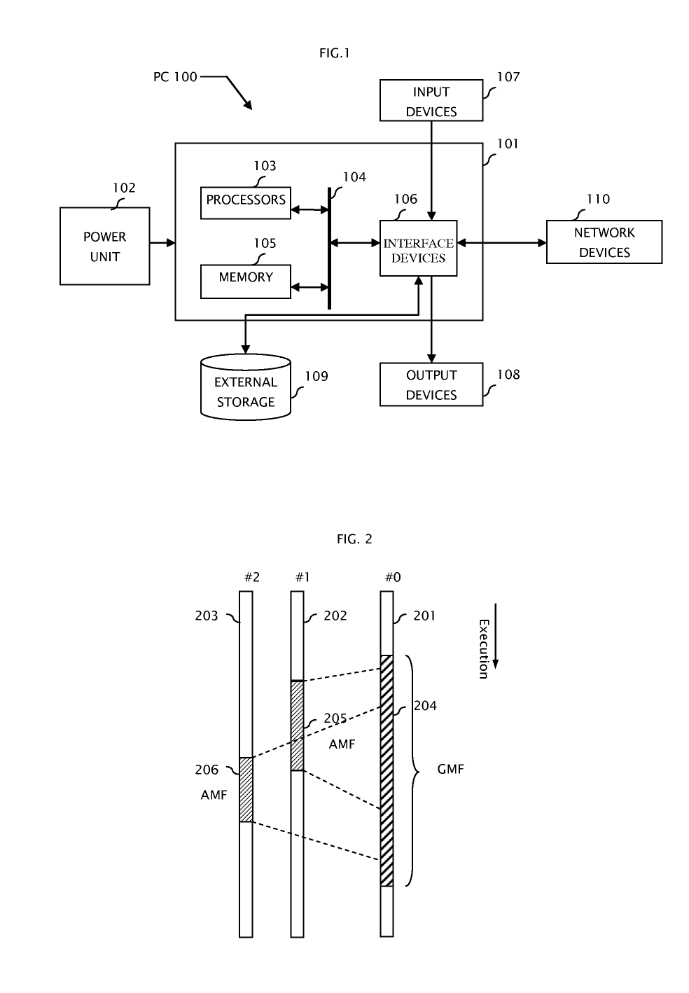

FIG. 2 shows the relationship between GMF and AMFs. There are 3 threads running respectively on 3 processors as #0 (201), #1 (202), and #2 (203). On processor #0, the thread 201 initiates a global memory fence (GMF) service call. During the GMF service 204 call, asynchronous memory fences are invoked and completed before the return of GMF, as show as 205, 206 in the figure.

Notice that, the AMF codes running on every other processor such as #1 and #2 in FIG. 2 are started after initiation of GMF service call and completed prior to the return of GMF service. Another trait of AMF is that it is always occurred as asynchronous event. It interrupts the normal flow of application threads, and may occur at any unpredictable place. Programmer should not assure that the AMF would occur at certain place or not occur at certain place.

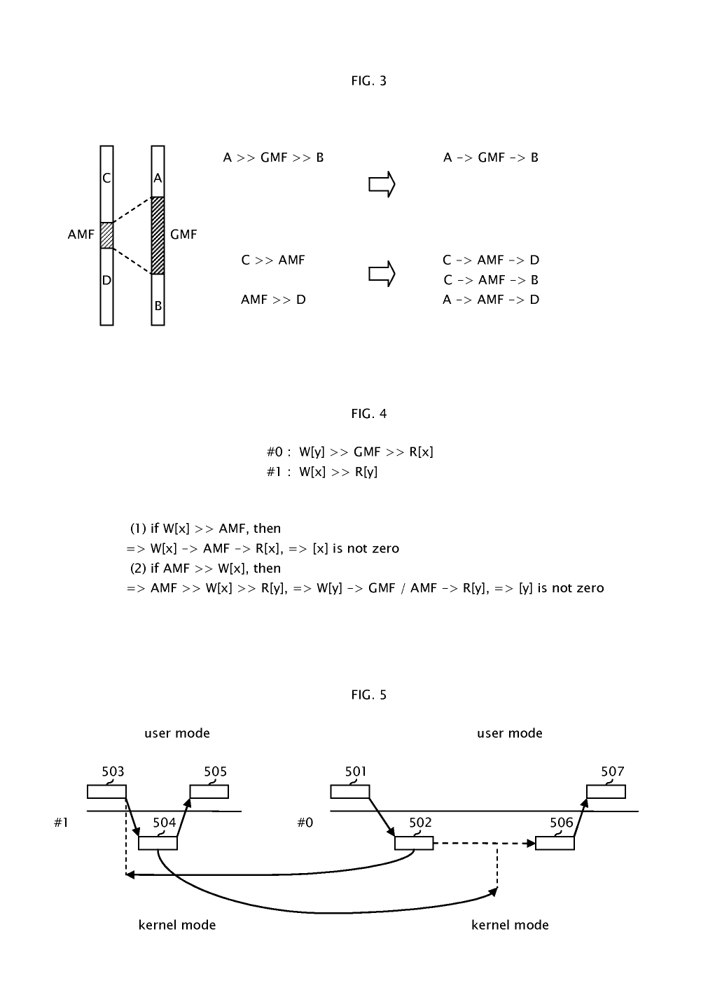

FIG. 3 shows the relationship of instructions around GMF and AMF. Suppose in program order, operations A precede the GMF call and operations B follow the return of GMF; GMF service call use memory fence to guarantee operations A become visible before GMF starts, and operations B become visible after GMF returns. (Of course, programmers are free to add memory fence instruction around the GMF call to ensure the ordering, so that it is not obligatory to do that inside GMF service.)

AMF code interrupts and separates the application codes into C and D. AMF executes a memory fence instruction, so that operations C are visible before operations D. Thus, from C>>AMF>>D, we get C→AMF→D.

AMF only runs inside the window of GMF, thus we have the result that, C→AMF→B and A→AMF→D.

To sum up, operations before GMF or AMF respectively on these own processors are visible before operations that are after GMF or AMF. For example, A and C are visible before B and D.

FIG. 4 shows how this GMF mechanism is applied to the example we mentioned before. Thread #0 (the Collector) invokes a GMF service call between W[y] (the SetFlag operation) and R[x] (the GC operation); Thread #1 (the Mutator) executes unordered operations W[x] (the SaveRef) and R[y] (the ChkFlag operation). When the asynchronous memory fence instruction executes, there is only two possibilities in respect to the W[x] (SaveRef operation): the result of W[x] operation is either visible or not. That is, (1) If the W[x] is visible, it means W[x]>>AMF, then because R[x] is visible after the return of GMF which means after the AMF, we have R[x] is visible after W[x], the ‘x’ is not zero; (2) if the W[x] is not visible, it means AMF>>W[x], then we have AMF>>W[x]>>R[y]. R[y] follows AMF thus when R[y] is visible, W[y] is sure be visible since W[y] is prior to GMF call. R[y] will see a non-zero value of ‘y’.

In this example, the thread #1 uses only unordered instructions. This eliminates the memory ordering semantics in this critical path of execution. If GMF service is not called frequently then the overall performance is improved.

In following sections, two embodiments are presented.

The first embodiment of the present invention uses inter-processor interrupts (IPI) to generate asynchronous memory fence on other processors. The GMF service is provided by operating system kernel such as a system call or a device driver control command. The service code sends IPI messages to every concerning processors (the caller can specify concerning processors via a parameter to the service call). The destination processor that receives the IPI message raises an asynchronous interrupt and transfers the execution into kernel mode. Then, our interrupt handler for this type of interrupt executes a memory fence instruction. That is the asynchronous memory fence on the destination processor. After executing the memory fence instruction, our interrupt handler set a mark in shared memory. And the last AMF interrupt handler will wake up the original thread which initiated the GMF services call.

FIG. 5 illustrates application program calls GMF service and generating AMF interrupts. When user-mode application program 501 on processor #0 calls GMF service, the processor traps into kernel mode and begins the GMF service. The GMF service procedure 502 sends inter-processors interrupts message to all other processors. Then, it waits on a synchronization object for the completion of all required AMF operations. As a result of IPI message, for example, the processor #1 currently running application code 503 is interrupted by the IPI message for the processor. Processor #1 traps into kernel mode to handle the IPI interrupt. The interrupt handler 504 executes the AMF code, which conducts a memory fence and then replies to processor #0 by some synchronization mechanisms, such as semaphore, event object, etc. After that, it returns from interrupt and continue the execution of the interrupted user code 505. When all other processors have done the AMF operations, processor #0 is waked up. The code 506 finishes the GMF service and returns to user-mode application program 507.

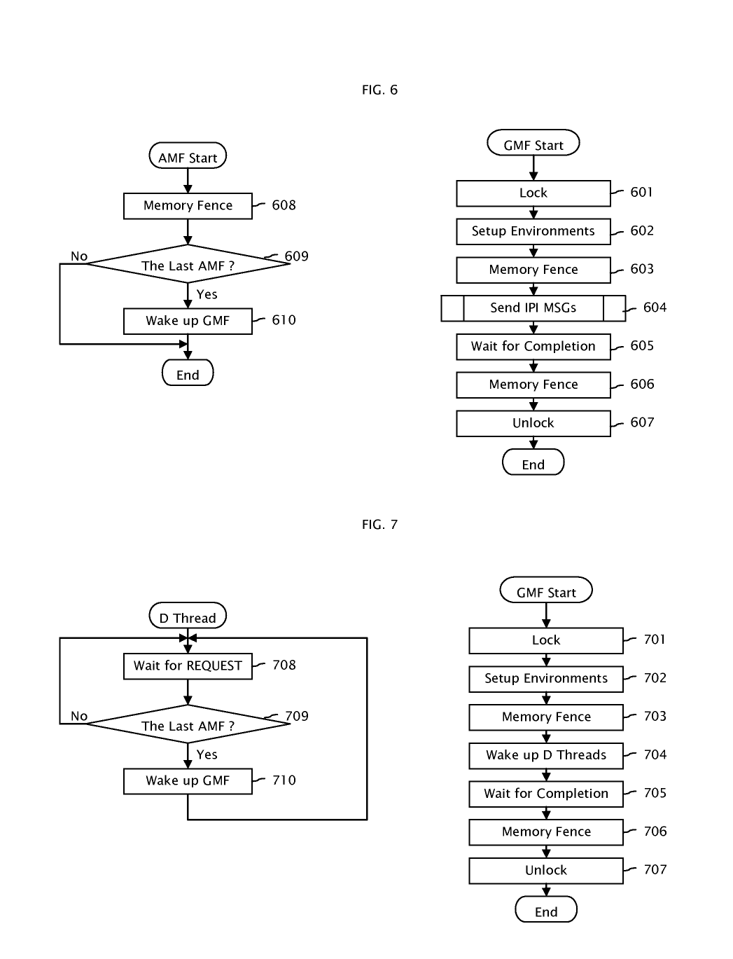

FIG. 6 is a flowchart of GMF and AMF code in embodiment 1 of the present invention. When an application program invokes the GMF service, the GMF routine begins. First, it locks in step 601 to ensure there is only one instance of GMF service running. In step 602, the GMF code setups some environments, such as the number of pending AMFs, which, at the beginning, should be the number of destination processors for IPI, and should be going to be decremented to zero when all processors have handled and completed their own IPI interrupt. In step 603, it executes a memory fence to ensure prior application instructions have completed. In step 604, it sends IPI messages to other processors to interrupt their executions asynchronously to execute the AMF code. Then, in step 605, it waits for completions of all pending AMF codes. When it was waked up, it means all AMF codes have completed. It executes another memory fence in step 606 to prevent speculative execution of the followed application codes. Finally, in step 607, it unlocks to allow other GMF to be executed and return to the caller of GMF service.

When a processor receives inter-processors interrupt message, it interrupts the current execution and transfer the control to the interrupt handler. The interrupt handler invokes the AMF code. In step 608, it executes a memory fence instruction to ensure the ordering of interrupted application code. All application instructions prior to the interrupt are guaranteed to be visible before the memory fence, and the memory fence is guaranteed to be visible before visibility of those application instructions that follows the interrupt. In step 609, it checks whether itself is the last AMF code running. Synchronization mechanism could be used to protect it from racing against other processors. For example, it can enter a critical section, decrement the pending AMF count as mentioned in an above section, check whether it reaches zero, and leave the critical section. If it is the last pending AMF code, it wakes up the GMF thread in step 610, by using synchronization mechanism such as SetEvent on an event object that GMF is waiting on. Finally, it returns from the interrupt and allows the interrupted application program to continue.

The second embodiment of the present invention will be presented herein. It uses processor affinity mechanism to guarantee AMF asynchronously running on destination processors, instead sending IPI message. It can be implemented all in user-mode. AMF codes are executed via operation system task scheduling mechanism instead via a direct interrupt handler. At the beginning of an application process, this system creates a set of dedicated application threads (D thread). Each of them is dedicated to a processor in the system or for this application process. Therefore, if there are N processors for a process, the amount of D threads in this process are N. The affinity property of each D thread is set to its designated processor respectively. The D thread will only run on the designated processor. When D thread is waked up and running, it means that the original running thread on the processor is preempted, and the processor has executed a memory fence due to the context switch.

FIG. 7 is a flowchart of a D thread and the GMF code. The GMF routine is almost the same as the embodiment 1 but executing in user-mode and having some changes. It uses synchronization mechanism to wake up D threads instead generate IPI interrupts on other processors. First, it locks in step 701 to ensure there is only one instance of GMF service running. In step 702, the GMF code setups some environments, such as the number of pending AMFs, which, at the beginning, should be the number of D threads, and should be going to be decremented to zero when all D threads have been waked up and replied. In step 703, it executes a memory fence to ensure prior application instructions are completed. In step 704, it wakes up all D threads by synchronization mechanism, such as calling SetEvent on an event object that D threads waiting on. Then, the GMF code waits in step 705 until the last AMF code wakes it up. When the GMF code is waked up, it executes another memory fence in step 706 to prevent speculative execution of the followed application codes. Finally, in step 707, it unlocks to allow other GMF to be executed, then returns to the caller of GMF service.

D threads, of their most time, are waiting for request in step 708, such as blocking by the system call WaitForSingleObject on an event object. When GMF code signals the event object, the D thread waiting on the object is waked up and scheduled to run on the designated processor. When the D thread gets the control, the processor has generated a context switch from original running thread to the D thread. It will cause a memory fence instruction or equivalence during the context switch. So, we don't need to explicitly execute a memory fence in the D thread. In step 709, it checks whether itself is the last AMF code. Synchronization mechanism could be used to protect it from racing against other processors. For example, it can enter a critical section, decrement the pending AMF count as mentioned in an above section, check whether it reaches zero, and leave the critical section. If it is the last pending AMF code, it wakes up the GMF thread in step 710, by such as signaling the event object that GMF is waiting on. Finally, it returns to step 708, sleeping and waiting for the next AMF request.

Note that, these flowcharts are oversimplified for better understanding the spirit of the invention. Some unrelated steps are omitted, such as every D thread may check for quit request when it was waked up. Another example, all D threads can wait on a single global event object as well as allocating a dedicated event object for every D thread.

Other variations can be easily implemented based on the spirit of the present invention. That is, GMF raises AMF operations on other processors, and waits for the completion of them. This ensures that operations preceding AMF are visible if operations following GMF are visible, and operations preceding GMF are visible if operations following AMF are visible. Future processor architecture may provide this mechanism in hardware. For example, processor architecture can provide a GMF instruction. The processor executing the GMF instruction communicates with other processors and collaborates with existing memory access coherency mechanism. It may not need to wait for the completion of asynchronous memory fence operations on other processors and can starts next instruction right after the AMF request is visible to other processors, providing that the memory access operations following the GMF is invisible to others until all others complete AMF operations and make the result visible. This does not beyond the principle of the present invention.

It is to be understood that the preferred embodiments and variations shown and described herein are merely illustrative of the principles of this invention and that various modifications may be implemented by those skilled in the art without departing from the scope and spirit of the invention.

What is claimed is:

1. A method of synchronization between processors, said method comprising:
within global memory fence (GMF) service call, other processor(s) are asynchronously raised to execute memory fence instruction or equivalence (AMF);
after all the other processor(s) have completed the execution the AMF code, the GMF service returns to the caller.

2. A method as claimed in claim 1 further comprising:
using inter-processor interrupt message(s) to deliver request of AMF to other processor(s); executing the memory fence(s) or equivalence(s) on other processors(s) in response to the IPI interrupt(s).

3. A method as claimed in claim 1 further comprising:
using processor affinity property of threads to assign a dedicated thread (D thread) for every related processor(s);
waking up the D thread(s) for scheduling within GMF;
informing GMF after D thread has been waken up and run on its dedicated processor.

4. A mechanism for synchronization between threads on multiple processors, it comprising:
a global memory fence (GMF) service that application program can call to synchronize behaviors of other processors;
within the GMF service call, asynchronous memory fence (AMF) or equivalence are raised to run on other processors;
after AMF(s) on other processor(s) have completed, the GMF service can return to the caller.

5. A mechanism for synchronization as in claim 4 further comprising:
the GMF service use inter-processor interrupts (IPI) to deliver requests for AMF to other processors;
memory fences or equivalences are executed on other processor(s) in response to the IPI interrupt(s).

6. A mechanism for synchronization as in claim 4 further comprising:
for each other processor, a dedicated thread (D thread) is created and only allowed to be run on the designated processor;
GMF service cause the D thread(s) ready for scheduling;
D thread(s) wake up on their dedicated processor(s), and inform back GMF.
